(19) United States
(12) Patent Application Publication
(10) Pub. No.: US 2005/0179841 A1
(43) Pub. Date: Aug. 18, 2005

(54) Transmissive and reflective mode fringe field switching liquid crystal display

(75) Inventor: Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/057,975

(22) Filed: Feb. 14, 2005

(30) Foreign Application Priority Data
Feb. 13, 2004 (TW) 93103445

(51) Int. Cl. G02F 1/1335; G02F 1/1343

(52) U.S. Cl. 349/114; 349/141

(57) ABSTRACT

A transmissive and reflective mode fringe field switching liquid crystal display (100) includes a backlight module for providing illumination, and a first substrate (110) and a second substrate (120) disposed opposite each other and spaced apart a predetermined distance. A liquid crystal layer (130) is interposed between the first and second substrates. A plurality of pixel electrodes (113) and a common electrode (111) are formed at the first substrate. The pixel electrodes are reflection electrodes defining a reflective display region of the liquid crystal display. Two polarizers (143, 141) are attached at the first and second substrates, respectively. At least one of the polarizers is disposed at an inner side of the corresponding substrate, and is thus protected by the substrate from damage by external factors. In certain embodiments, a color filter is disposed above both the polarizers. Therefore the liquid crystal display can eliminate any de-polarizing effects of the color filter.

### FIELD OF THE INVENTION

The present invention relates to fringe field switching liquid crystal displays (FFS-LCDs), and especially to a transmissive and reflective transflecive mode FFS-LCD.

### BACKGROUND OF THE INVENTION

Liquid crystal displays (LCDs) are used as displays on a variety of devices such as, for example, computer monitors and motor vehicle cruise control panels. Existing LCD types include, for example, the twisted nematic liquid crystal display (TN-LCD) and the in-plane switching liquid crystal display (IPS-LCD). The TN-LCD often has the problem of a narrow viewing angle, and so the IPS-LCD was developed to overcome this disadvantage. The IPS-LCD typically has one or more common electrodes and a plurality of pixel electrodes all disposed on one of two opposite substrates. The electrodes drive liquid crystal molecules interposed between the substrates with an electric field. The resulting electric field is substantially in a plane parallel to the substrates. Such a configuration provides a wide viewing angle.

However, the common electrodes and pixel electrodes are formed of opaque metals, giving the IPS-LCD a low aperture ratio and low transmittance. Thus a fringe field switching liquid crystal display (FFS-LCD) with a flat plate-like common electrode has been developed in order to improve on the aperture ratio and transmittance. The FFS-LCD is characterized by its driving electric field, which is between each pixel electrode and the common electrode. Because the common electrode is transparent, the FFS LCD can typically attain a higher aperture ratio and a higher transmittance.

FIG. 5 is a schematic, cross-sectional view of a conventional transmission mode FFS-LCD 1. The FFS-LCD 1 comprises an upper substrate 20 and an opposite lower substrate 10, with the substrates 20, 10 being spaced apart a predetermined distance. A liquid crystal layer 50 having a multiplicity of liquid crystal molecules (not labeled) is disposed between the upper and lower substrates 20, 10. A backlight module (not shown) is disposed under the lower substrate 10 for providing illumination.

A common electrode 11 and a plurality of pixel electrodes 13 are disposed at the lower substrate 10, with an insulating layer 12 interposed between the common electrode 11 and the pixel electrodes 13. A lower alignment film 14 is formed on the insulating layer 12, such that the lower alignment film 14 also covers the pixel electrodes 13. A color filter 25 and an upper alignment film 24 are formed on an inner surface of the upper substrate 20, in that order from top to bottom. Two polarizers 40, 30 are attached on outer surfaces of the upper substrate 20 and the lower substrate 10, respectively. The polarizers 40, 30 are ordinary type polarizers made of polyvinyl alcohol (PVA). The ordinary type polarizers 40, 30 allow passage of ordinary light (O light) which is polarized in one direction, while blocking extraordinary light (E light) which is polarized in another direction. Polarizing axes of the polarizers 40, 30 are perpendicular to each other. In such an arrangement, the polarizers are called “crossed polarizers.”

When the FFS-LCD 1 is driven, a fringe electric field is formed between the common electrode 11 and each pixel electrode 13. The liquid crystal molecules disposed over the common electrode 11 and pixel electrodes 13 are driven by this electric field and have a corresponding orientation. In various regions, orientations of the liquid crystal molecules are determined by the voltage applied in the region. The orientations of the liquid crystal molecules determine the transmittance of the region.

Because the polarizers are both positioned as outer surfaces of the typical FFS-LCD 1, they are easily damaged or even destroyed in handling or in use. In addition, the FFS-LCD 1 is a transmission mode LCD which typically requires the backlight module for illumination. The backlight module consumes power from a power source of the FFS-LCD 1.

Further, the color filter 25 typically has a de-polarizing effect on light beams passing therethrough, due to pigment light scattering. That is, light beams passing through the FFS-LCD 1 are partially de-polarized by the color filter layer before reaching the upper polarizer 40. This de-polarizing of the light beams can reduce the contrast ratio of the FFS-LCD 1.

Moreover, light leakage may occur at oblique viewing angles due to the polarizers 30, 40 being ordinary type polarizers. The leakage of light beams through the pair of crossed polarizers 30, 40 is typically proportional to the viewing angle. Referring to FIG. 4, the dashed curve I is the contrast ratio for the polarizers 30, 40. As seen in FIG. 4, the FFS-LCD 1 has a high contrast ratio at a zero-degree viewing angle which is perpendicular to the LCD. However, the contrast ratio deteriorates rapidly when viewing from oblique directions further and further away from the zero-degree viewing angle. Thus the FFS-LCD 1 with two ordinary type polarizers is highly viewing angle dependent.

What is needed, therefore, is to provide a transmissive and reflective mode fringe field switching liquid crystal display which is resistant to damage and has low power consumption.

### SUMMARY

A transmissive and reflective mode fringe field switching liquid crystal display of the present invention includes a backlight module for providing illumination, and a first substrate and a second substrate disposed opposite each other and spaced apart a predetermined distance.

In a preferred embodiment, a liquid crystal layer is interposed between the first substrate and the second substrate. A plurality of pixel electrodes and a common electrode is formed at the first substrate. Two polarizers are attached at the first substrate and the second substrate respectively. At least one of the polarizers is disposed at an inner side of the corresponding substrate. The pixel electrodes are reflection electrodes defining a reflective region of the liquid crystal display.

Because at least one of the polarizers is preferably at an inner side of the corresponding substrate, it is protected by the substrate from damage by external factors. The reflection electrodes may also help utilize ambient light beams, thus reducing the need to use the backlight module. The liquid crystal display can be used in both dark and bright conditions, and has low power consumption in bright conditions.

In some embodiments of the present invention, a color filter is disposed above both the polarizers. Therefore the liquid crystal display reduces or eliminates any de-polarizing effects of the color filter. Further, with at least one extraordinary type polarizer, the liquid crystal display attains better viewing angle characteristics.

Other advantages and novel features of the present invention will become more apparent from the following detailed description of preferred embodiments when taken in conjunction with the accompanying drawings, in which:

### BRIEF DESCRIPTION OF THE DRAWINGS

FIG. 1 is a schematic, side cross-sectional view of part of an FFS-LCD according to a first embodiment of the present invention;

FIG. 2 is a schematic, side cross-sectional view of part of an FFS-LCD according to a second embodiment of the present invention;

FIG. 3 is a schematic, side cross-sectional view of part of an FFS-LCD according to a third embodiment of the present invention;

FIG. 4 is a graph showing a relationship between contrast ratio and viewing angle, in respect of the FFS-LCD of the first embodiment of the present invention and in respect of a conventional FFS-LCD; and

FIG. 5 is a schematic, side cross-sectional view of part of the conventional FFS-LCD.

### DETAILED DESCRIPTION OF PREFERRED EMBODIMENTS

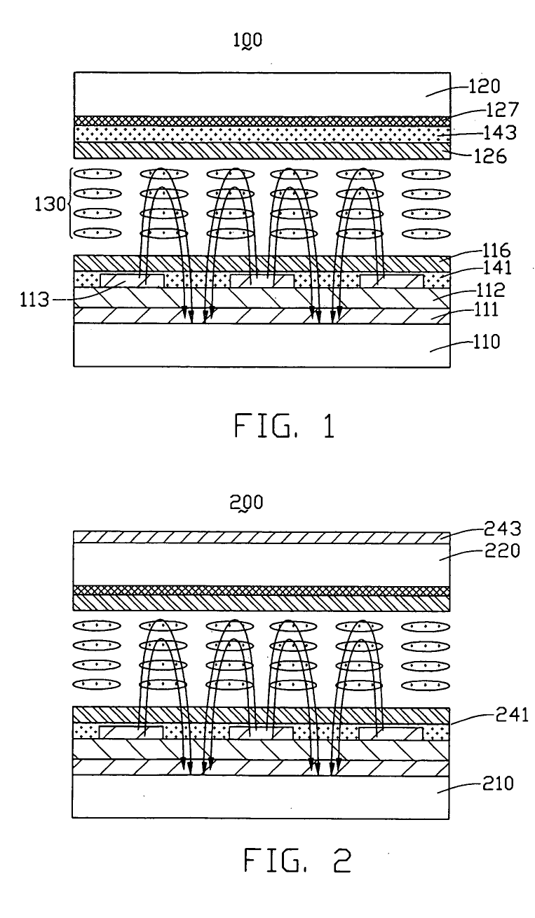

FIG. 1 is a schematic, cross-sectional view of part of a transmissive and reflective mode fringe field switching liquid crystal display (FFS-LCD) 100 according to a first embodiment of the present invention. The transmissive and reflective mode FFS-LCD 100 comprises a first substrate 110, a second substrate 120, and a liquid crystal layer 130 having a multiplicity of liquid crystal molecules (not labeled). A backlight module (not shown) is disposed under the first substrate 110. The first substrate 110 and the second substrate 120 are spaced apart from each other, and the liquid crystal layer 130 is disposed therebetween. The first substrate 110 and the second substrate 120 are made of glass. Alternatively, the first substrate 110 and the second substrate 120 can be made of silicon dioxide (SiO₂).

A common electrode 111 and a plurality of pixel electrodes 113 are disposed at the first substrate 110, with a transparent insulating layer 112 interposed between the common and pixel electrodes 111, 113. A polarizer 141 and an alignment film 116 are formed on the insulating layer 112 in that order from bottom to top, with the polarizer 141 also covering the pixel electrodes 113. A color filer 127, a polarizer 143 and an alignment film 126 are formed on an underside of the second substrate 120, in that order from top to bottom.

The alignment films 116, 126 are horizontal alignment layers with a low pretilt angle below 3° for substantially orientating the liquid crystal molecules parallel to the substrates 110, 120. The common electrode 111 is plate-shaped, and is preferably made of a transparent conductor such as indium tin oxide (ITO) or indium zinc oxide (IZO). Each pixel electrode 113 is strip-shaped, and is made of a conductor having high reflectivity such as aluminum (Al) or silver (Ag). The pixel electrodes 113 are reflective electrodes for reflecting light beams from the ambient environment, and define a reflective region of the FFS-LCD 100.

The color filter 127 preferably includes a black matrix (not shown), and a color resin layer (not shown) having Red, Green and Blue segments. The black matrix is disposed between the segments of the color resin layer to prevent light beams from leaking between segments. The insulating layer 112 is used to prevent electrostatic buildup, and is made of SiO₂ or silicon nitride (SiNx).

The polarizers 141, 143 are preferably extraordinary type polarizers. That is, the polarizers 141, 143 allow extraordinary light beams to pass therethrough, but block ordinary light beams from passing therethrough. The polarizers 141, 143 are composed of mixtures of narrow-band components. Each component consists of a modified organic dye material which is in a liquid-crystalline phase. Polarizing axes of the polarizers 141, 143 are perpendicular to each other; that is, the polarizers 141, 143 are crossed polarizers. A thickness of each of the polarizers 141, 143 is less than 100 micrometers.

When a voltage is applied to the common electrode 111 and the pixel electrodes 113, a fringe electric field is produced therebetween at each of pixels. Long axes of the liquid crystal molecules are oriented parallel to the fringe electric field. Light beams from the backlight module pass up through the liquid crystal layer 130. Light beams from the ambient environment pass down through the liquid crystal layer 130, are next reflected back by the pixel electrodes 113, and then pass up through the liquid crystal layer 130 again. The state of polarization of the light beams is changed when they pass through the liquid crystal layer 130. Therefore the light beams transmitting through the liquid crystal layer 130 can pass through the polarizer 143. The light beams emitted from the polarizer 143 subsequently pass through the color filter 127 and the second substrate 120. As a result, the transmissive and reflective mode FFS-LCD 100 is in a bright state.

When no voltage is applied to the common electrode 111 and the pixel electrodes 113, the long axes of the liquid crystal molecules in the liquid crystal layer 130 preferably maintain a predetermined angle relative to the upper alignment film 126 and the lower alignment film 116, and the liquid crystal molecules are stationed parallel to the substrates 110, 120. In such condition, the state of polarization of light beams is not changed when the light beams pass through the liquid crystal layer 130. Therefore, the light beams cannot pass through the polarizer 143 formed at the second substrate 120. As a result, the transmissive and reflective mode FFS-LCD 100 is in a dark state.

The polarizers 141, 143 are preferably formed at inner sides of the substrates 120, 110 respectively, and are therefore protected from being damaged by foreign matter or disturbances. Because the transmissive and reflective mode FFS-LCD 100 can use the ambient environment for display, it can be operated in a bright ambient light environment with the backlight module turned off. Therefore the FFS-LCD 100 has enhanced reliability and power consumption performance.

Furthermore, the color filter 127 is disposed under the second substrate 120 above the polarizer 143. Light beams from the backlight module do not pass through the color filter 127 before reaching the polarizers 141, 143. This arrangement reduces or eliminates any de-polarizing effect of the color filter 127.

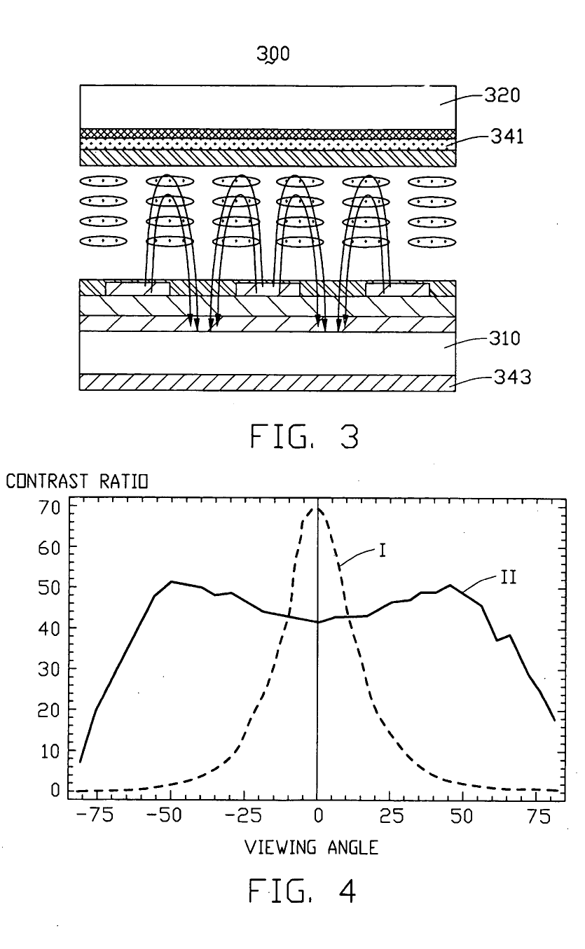

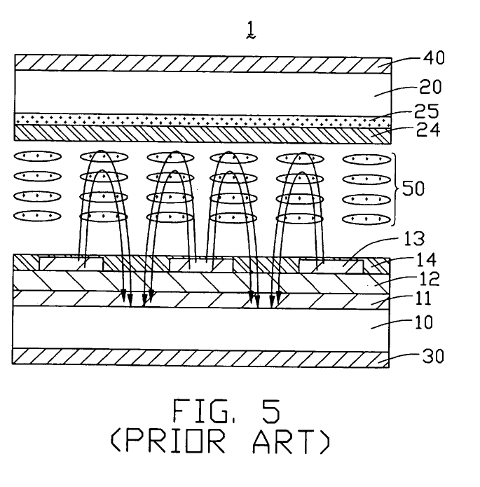

The leakage of light beams through the pair of crossed extraordinary type polarizers 141, 143 is inversely proportional to the viewing angle. That is, light leakage at larger viewing angles is small. Referring to FIG. 4, the continuous curve II is the contrast ratio for the polarizers 141, 143. It illustrates that the polarizers 141, 143 have a good contrast ratio at oblique viewing angles due to less light leakage.

FIG. 2 is a schematic, cross-sectional view of part of a transmissive and reflective mode FFS-LCD 200 according to a second embodiment of the present invention. The transmissive and reflective mode FFS-LCD 200 is similar to the transmissive and reflective mode FFS-LCD 100 of the first embodiment, and comprises a first substrate 210 and a second substrate 220. An extraordinary type polarizer 241 is formed at an inner surface of the first substrate 210, and an ordinary type polarizer 243 is formed on an outer surface of the second substrate 220. The polarizer 243 and the polarizer 241 are crossed polarizers. A leakage of the transmissive and reflective mode FFS-LCD 200 is a product of the leakage generated by an ordinary type polarizer and an extraordinary type polarizer. An ordinary type polarizer typically exhibits the smallest leakages at smaller viewing angles, and an extraordinary type polarizer typically exhibits the smallest leakages at larger viewing angles. Therefore the result of the combination of the two types of polarizers is a small leakage over a wide range of viewing angles.

The polarizer 241 is formed at the inner side of the substrate 210, and therefore be well protected. The FFS-LCD 200 also can use the ambient environment for display, therefore can be operated in a bright ambient light environment with the backlight module turned off. So the FFS-LCD 200 also has an enhanced reliability and low power consumption, like that of the FFS-LCD 100.

FIG. 3 shows a schematic, cross-sectional view of part of a transmissive and reflective mode FFS-LCD 300 according to a third embodiment of the present invention. The transmissive and reflective mode FFS-LCD 300 is similar to the transmissive and reflective mode FFS-LCD 200, and comprises a first substrate 310 and a second substrate 320. An extraordinary type polarizer 341 is formed at an inner surface of the second substrate 320, and an ordinary type polarizer 343 is formed on an outer surface of the first substrate 310. Polarizing axes of the polarizers 341, 343 are perpendicular to each other. A color filter (not labeled) is disposed between the second substrate 320 and the polarizer 341. Like the FFS-LCD 200, the FFS-LCD 300 uses the combination of the two types of polarizers, and exhibits a small leakage over a wide range of viewing angles.

The polarizer 341 is formed at the inner side of the substrate 320, and therefore be well protected. The FFS-LCD 300 also can use the ambient environment for display, therefore can be operated in a bright ambient light environment with the backlight module turned off. So the FFS-LCD 300 also has an enhanced reliability and low power consumption.

In alternative embodiments, each pixel electrode 113 can have a main portion made of a transparent material, and a reflective layer formed on the main portion for providing the needed reflection.

It is to be understood, however, that even though numerous characteristics and advantages of have been set forth in the foregoing description of the preferred embodiments, together with details of the structures and functions of the preferred embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

1. A transmissive and reflective mode fringe field switching liquid crystal display, comprising:
a first substrate and a second substrate disposed opposite each other and spaced apart a predetermined distance;
a liquid crystal layer interposed between the first substrate and the second substrate;
a plurality of pixel electrodes and a common electrode formed at the first substrate, the pixel electrodes being reflection electrodes defining a reflective region of the liquid crystal display; and
an upper polarizer and a lower polarizer formed at the second substrate and the first substrate, respectively, at least one of the polarizers being disposed at an inner side of the corresponding substrate.

2. The transmissive and reflective mode fringe field switching liquid crystal display as claimed in claim 1, further comprising a color filter, the color filter being disposed above both of the polarizers.

3. The transmissive and reflective mode fringe field switching liquid crystal display as claimed in claim 2, further comprising a backlight module disposed under the first substrate.

4. The transmissive and reflective mode fringe field switching liquid crystal display as claimed in claim 1, wherein both polarizers are extraordinary type polarizers.

5. The transmissive and reflective mode fringe field switching liquid crystal display as claimed in claim 4, wherein each extraordinary type polarizer is made of an organic dye material which exists in a liquid crystalline phase.

6. The transmissive and reflective mode fringe field switching liquid crystal display as claimed in claim 1, wherein one of the polarizers is an extraordinary type polarizer, and the other polarizer is an ordinary type polarizer.

7. The transmissive and reflective mode fringe field switching liquid crystal display as claimed in claim 6, wherein the extraordinary type polarizer is made of an organic dye material which exists in a liquid crystalline phase.

8. The transmissive and reflective mode fringe field switching liquid crystal display as claimed in claim 1, wherein each pixel electrode comprises a conductive material having high reflectivity.

9. The transmissive and reflective mode fringe field switching liquid crystal display as claimed in claim 8, wherein the pixel electrode is made of aluminum.

10. The transmissive and reflective mode fringe field switching liquid crystal display as claimed in claim 8, wherein the pixel electrode comprises a main portion made of a transparent material, and a reflective layer formed on the main portion.

11. A transmissive and reflective mode fringe field switching liquid crystal display, comprising:
a first substrate and a second substrate disposed opposite each other and spaced apart a predetermined distance;
a liquid crystal layer interposed between the first substrate and the second substrate;
a common electrode disposed on the first substrate;
a plurality of pixel electrodes disposed at the first substrate, a fringe electric field having horizontal components being generated between the pixel electrodes and the common electrode when a voltage is applied therebetween;
an upper polarizer and a lower polarizer attached at the second substrate and the first substrate, respectively, at least one of the polarizers being disposed at an inner side of the corresponding substrate; and
a plurality of reflection regions for reflection of ambient light.

12. The transmissive and reflective mode fringe field switching liquid crystal display as claimed in claim 11, further comprising a color filter, the color filter being disposed above both of the polarizers.

13. The transmissive and reflective mode fringe field switching liquid crystal display as claimed in claim 12, further comprising a backlight module disposed under the first substrate.

14. The transmissive and reflective mode fringe field switching liquid crystal display as claimed in claim 11, wherein both polarizers are extraordinary type polarizers.

15. The transmissive and reflective mode fringe field switching liquid crystal display as claimed in claim 11, wherein one of the polarizers is an extraordinary type polarizer, and the other polarizer is an ordinary type polarizer.

16. The transmissive and reflective mode fringe field switching liquid crystal display as claimed in claim 15, wherein the extraordinary type polarizer is made of an organic dye material which exists in a liquid crystalline phase.

17. The transmissive and reflective mode fringe field switching liquid crystal display as claimed in claim 11, wherein each pixel electrode comprises a conductive material having high reflectivity.

18. The transmissive and reflective mode fringe field switching liquid crystal display as claimed in claim 17, wherein the pixel electrode is made of aluminum.

19. The transmissive and reflective mode fringe field switching liquid crystal display as claimed in claim 17, wherein the pixel electrode comprises a main portion made of a transparent material, and a reflective layer formed on the main portion.

20. A transmissive and reflective mode fringe field switching liquid crystal display, comprising:
a first substrate and a second substrate disposed opposite each other and spaced apart a predetermined distance;
a liquid crystal layer interposed between the first substrate and the second substrate;
a common electrode disposed on the first substrate;
a plurality of pixel electrodes disposed at the first substrate, a fringe electric field having horizontal components being generated between the pixel electrodes and the common electrode when a voltage is applied therebetween;
a filter disposed on the second substrate; and
an extraordinary polarizer disposed on the second substrate while closer to the liquid crystal layer than said filter.
